(19) United States
(12) Patent Application Publication
(10) Pub. No.: US 2008/0202384 A1
(43) Pub. Date: Aug. 28, 2008

(54) Fluoropolymer compositions and method of use

(76) Inventors: Sheng Peng, Wilmington, DE (US); Stephen James Getty, Wilmington, DE (US); Patrick Henry Fitzgerald, Pitman, NJ (US); Peter Michael Murphy, Chadds Ford, PA (US); Ying Wang, West Chester, PA (US); Ernest Byron Wysong, Hockessin, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/712,324

(22) Filed: Feb. 28, 2007

(51) Int. Cl. C09K 3/18; C08F 10/00; C08F 14/18

(52) U.S. Cl. 106/287.22; 106/287.25; 526/242; 526/245

(57) ABSTRACT

A composition comprising monomers copolymerized in the following percentages by weight: (a) from about 20% to about 95% of a monomer, or mixture of monomers, of formula (I):

R_{f}—(CH₂CF₂)_{q}(CH₂CH₂)ᵣ-Z-C(O)—C(R)═CH₂ (I)

wherein
q and r are each independently integers of 1 to 3;
R_{f} is a linear or branched perfluoroalkyl group having 2 to 6 carbon atoms;
Z is —O—, —NR¹— or —S—;
R is hydrogen, Cl, F or CH₃;
R¹ is hydrogen, or a C₁ to C₄ alkyl; and (b) from about 5% to about 80% of at least one of: (i) an alkyl (meth)acrylate monomer having a linear, branched or cyclic alkyl group of 6 to 18 carbons; or (ii) a monomer of formula (II):

(R²)₂N—R³—O—C(O)—C(R)═CH₂ (II)

wherein
R is as defined above;
each R² is independently a C₁ to C₄ alkyl; and
R³ is a divalent linear or branched C₁ to C₄ alkylene; and wherein the nitrogen is from about 40% to 100% salinized; or (iii) a mixture thereof; said composition providing oil repellency, water repellency, and stain resistance to substrates contacted therewith; and a method for treating substrates with such copolymer compositions; are disclosed.

### FIELD OF INVENTION

The present invention relates to compositions comprising fluorinated copolymers useful for imparting oil repellency, water repellency and stain resistance to textiles, hard surfaces, and paper. The copolymers are derived from copolymerization of monomers including fluorinated (meth)acrylates and other comonomers.

### BACKGROUND

Various compositions are known to be useful as treating agents to provide surface effects to substrates. Surface effects include repellency to moisture, oil, and stains, and other effects, which are particularly useful for textile substrates and other substrates such as hard surfaces. Many such treating agents are fluorinated polymers or copolymers.

Most commercially available fluorinated polymers useful as treating agents for imparting repellency to substrates contain predominately eight or more carbons in the perfluoroalkyl chain to provide the desired repellency properties. Honda et al., in Macromolecules, 2005, 38, 5699-5705 show that for perfluoroalkyl chains of 8 carbons or greater, orientation of the perfluoroalkyl groups is maintained in a parallel configuration, while reorientation occurs for such chains having 6 carbon atoms or less. Such reorientation decreases surface properties such as receding contact angle. Thus, shorter chain perfluoroalkyls have traditionally not been successful commercially.

U.S. Pat. No. 3,890,376 discloses a preparation of (meth)acrylate monomers derived from fluoroalcohols having a perfluoroalkyl group having 6 or more carbon atoms linked to a vinylidine fluoride and ethylene linking groups. Although the monomers, and polymers derived therefrom, were considered potentially useful surface treating agents for textiles, the polymers were not prepared, and useful properties never demonstrated. Furthermore, homopolymers derived from such monomers would not typically be expected to have the emulsion stability, processability and cost benefits, necessary to make a successful commercial surface-treating agent.

There is a need for copolymer compositions that impart significant water repellency, oil repellency and stain resistance to textile substrates and hard surface substrates while having perfluoroalkyl groups with six or less carbon atoms. The present invention provides such compositions

### SUMMARY OF INVENTION

The present invention comprises a copolymer composition comprising monomers copolymerized in the following percentages by weight:
(a) from about 20% to about 95% of a monomer, or mixture of monomers, of formula (I):

R_{f}—(CH₂CF₂)_{q}(CH₂CH₂)ᵣ-Z-C(O)—C(R)═CH₂ (I)

wherein
q and r are each independently integers of 1 to 3;
R_{f} is a linear or branched perfluoroalkyl group having 2 to 6 carbon atoms;
Z is —O—, —NR— or —S—;
R is hydrogen, Cl, F or CH₃;
R¹ is hydrogen, or a C₁ to C₄ alkyl; and
(b) from about 5% to about 80% of at least one of:
(i) an alkyl (meth)acrylate monomer having a linear, branched or cyclic alkyl group of 6 to 18 carbons; or
(ii) a monomer of formula (II):

(R²)₂N—R³—O—C(O)—C(R)═CH₂ (II)

wherein
R is hydrogen, Cl, F or CH₃;
each R² is independently a C₁ to C₄ alkyl; and
R³ is a divalent linear or branched C₁ to C₄ alkylene; and
wherein the nitrogen is from about 40% to 100% salinized; or
(iii) a mixture thereof;
said composition providing oil repellency, water repellency, and stain resistance to substrates contacted therewith.

The present invention further comprises a method of treating a substrate to impart oil repellency, water repellency and stain resistance comprising contacting the substrate with a copolymer composition of the invention as disclosed above.

The present invention further comprises a substrate having contacted a copolymer composition of the invention as described above.

### DETAILED DESCRIPTION OF INVENTION

Herein all trademarks are designated with capital letters. All patents cited herein are hereby incorporated by reference.

The term “(meth)acrylate” encompasses esters of methacrylic acid and acrylic acid unless specifically stated otherwise. For instance, hexyl (meth)acrylate encompasses both hexyl acrylate and hexyl methacrylate. The term “(meth)acrylamide” encompasses amides of methacrylic acid and acrylic acid unless specifically stated otherwise.

Herein the terms “fluorinated acrylate(s)” “fluorinated thioacrylate(s)” and “fluorinated acrylamide(s)” refers to compounds of formula (I), wherein R is selected from the group consisting of H, Cl, F, and CH₃, unless specifically defined otherwise.

The present invention comprises a copolymer composition that imparts significant water repellency, oil repellency, and stain resistance to substrates treated therewith wherein the copolymer contains a perfluoroalkyl group of six or more carbons. The copolymer comprises component (a) of formula (I) as defined above, and at least one component (b)(i), (b)(ii), or a mixture thereof, as defined above. The copolymer optionally further comprises at least one additional monomer (c), monomer (d), monomer (e), or any mixture of such additional monomers, as defined hereinafter in further embodiments.

In all embodiments of the invention, including methods, compositions, substrate provided by said methods, and substrates having been contacted with said compositions, preferred copolymers comprise monomers of formula (I) wherein Z is —O—, q is 1 or 2, r is 1, R is hydrogen or CH₃, and R_{f} has 2 to 6 carbons. More preferred are copolymers comprising monomers of formula (I) wherein R_{f} has 4 to 6 carbon atoms; and most preferred are copolymers wherein R is CH₃ and R_{f} has 6 carbon atoms.

One embodiment of the present invention is a copolymer composition, providing oil repellency, water repellency and stain resistance, comprising monomers copolymerized in the following percentages by weight: component (a) comprising from about 20% to about 95%, and preferably from about 40% to about 95%, of a monomer, or mixture of monomers, of formula (I):

R_{f}—(CH₂CF₂)_{q}(CH₂CH₂)ᵣ-Z-C(O)—C(R)═CH₂ (I)

wherein
q and r are each independently integers equal to 1 to 3;
R_{f} is a linear or branched perfluoroalkyl group having 2 to 6 carbon atoms;
Z is —O—, —NR¹— or —S—;
R is hydrogen, Cl, F or CH₃; and
R¹ is hydrogen, or a C₁ to C₄ alkyl; and component (b)(i) comprising from about 5% to about 80%, and preferably from about 5% to about 60%, of one or more monomers of an alkyl (meth)acrylate having a linear, branched or cyclic alkyl group having from about 6 to about 18 carbons. More preferably the copolymer composition comprises from about 50% to about 85% and, more preferably, from about 60% to about 85%, of component (a), that is, the monomers of formula (I). Preferably the proportion of component (b)(i), alkyl (meth)acrylates, is between about 15% to about 30% by weight. Preferred alkyl (meth)acrylate monomers include stearyl (meth)acrylate, 2-ethylhexyl (meth)acrylate, hexyl (meth)acrylate, cyclohexyl (meth)acrylate, lauryl (meth)acrylate, tridecyl (meth)acrylate, or a mixture thereof. Of the foregoing, stearyl (meth)acrylate and 2-ethylhexyl (meth)acrylate are most preferred.

Another embodiment of the invention is a copolymer composition, providing oil repellency, water repellency and stain resistance, comprising monomers copolymerized in the following percentages by weight: component (a) comprising from about 20% to about 95%, and preferably from about 40% to about 95%, of a monomer, or mixture of monomers, of formula (I), as defined above; and component (b)(ii) comprising from about 5% to about 80%, and preferably from about 5% to about 60%, of one or more monomers of formula (II):

(R²)₂N—R³—O—C(O)—C(R)═CH₂ (II)

wherein
R is hydrogen, Cl, F or CH₃;
R²is a C₁ to C₄ alkyl;

R³ is a divalent linear or branched C₁ to C₄ alkylene; and wherein the nitrogen is from about 40% to 100% salinized. Preferably component (a) is present at from about 50% to about 85% and component (b)(ii) is present at from about 10% to about 40%. Preferred monomers of formula (II) include 2-(N,N-dimethylamino)ethyl(meth)acrylate, and 3-(N,N-dimethylamino)propyl (meth)acrylate.

The term “wherein the nitrogen is from about 40% to 100% salinized” means that the nitrogen atom of monomer (II) is present in a protonated or alkylated form or a partially protonated or partially alkylated form. This can be accomplished before, during or after the polymerization of the monomers. The salinization of the nitrogen of formula (II) provides useful water dispersibility properties to the polymers derived therefrom. A convenient and preferred approach to providing copolymers comprising partially or fully salinized monomers of formula (II) comprises polymerizing to provide a copolymer composition, followed by dispersing the copolymer with an aqueous acid solution. Examples of such acids are hydrochloric, hydrobromic, sulfuric, nitric, phosphoric, acetic, formic, propionic or lactic acids. Preferably, acetic acid is used, and preferably the nitrogen is fully salinized. Full salinization can be accomplished by using about 1 to about 2 equivalents of acid, based on the equivalents of monomer (II) present in the copolymer.

Another embodiment of the invention is a copolymer composition comprising monomers copolymerized in the following percentages by weight: component (a) comprising from about 20% to 95%, and preferably from about 40% to about 95%, of a monomer, or mixture of monomers, of formula (I), as defined above; and component (b) from about 5% to about 80%, and preferably from about 5% to about 60%, of a mixture of monomers of (b)(i) an alkyl (meth)acrylate and (b)(ii) formula (II), each as defined above.

Another embodiment of the present invention comprises a copolymer composition comprising component (a) as defined above, component (b)(i) or (b)(ii) or a mixture thereof as defined above, and further comprising at least one additional monomer copolymerized in the following percentage by weight:

(c) from about 1% to about 35% vinylidene chloride, vinyl chloride, or vinyl acetate, or a mixture thereof; or

(d) from about 0.5% to about 25% of at least one monomer selected from the group consisting of styrene, methyl-substituted styrene, chloromethyl-substituted styrene, 2-hydroxyethyl (meth)acrylate, ethylenediol di(meth)acrylate, N-methyloyl (meth)acrylamide, C₁-C₅ alkyl (meth)acrylate, and a compound of formula (III):

R⁴(OCH₂CH₂)ₘO—C(O)—C(R)═CH₂ (III)

wherein
m is 2 to about 10;
R⁴ is hydrogen, a C₁ to C₄ alkyl, or CH₂═C(R)C(O)—O—; and
each R is hydrogen, Cl, F or CH₃; or
(e) from about 0.5% to about 10% of at least one monomer of formula (IVa), (IVb) or (IVc):

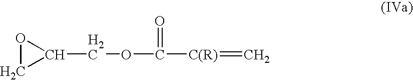

(R⁵O)₃Si—B¹-Z-C(O)—C(R)═CH₂ (IVb)

(R⁴O)₃Si—B²—C(R¹)═CH₂ (IVc)

wherein
each R is independently hydrogen, Cl, F or CH₃;
R⁵ is a linear or branched C₁ to C₄ alkyl;
B¹ is a divalent linear or branched C₂ to C₄ alkylene;
B² is a covalent bond or a divalent linear or branched C₁ to C₄ alkylene; and
Z is —O—, —NR¹—, or —S—; wherein R¹ is hydrogen, or a C₁ to C₄ alkyl; or
(f) any combination thereof.

Thus monomers (a) and (b) are copolymerized with 1) monomer (c), 2) monomer (d), 3) monomer (e), 4) monomers (c) and (d), 5) monomers (d) and (e), 6) monomers (c) and (e), or 7) monomers (c), (d), and (e).

A preferred embodiment of the present invention comprises a copolymer composition comprising component (a) as defined above, and component (b)(i) or (b)(ii) or a mixture thereof as defined above, and wherein the additional monomer copolymerized is component (c), defined as from about 1% to about 35% by weight of vinylidene chloride, vinyl chloride, vinyl acetate, or a mixture thereof. Preferred compositions comprise component (a), component (b)(i), and from about 10% to about 30% of component (c) and, most preferably the monomer (c) is vinylidene chloride, vinyl chloride, or a mixture thereof.

Another preferred embodiment of the present invention comprises a copolymer composition comprising component (a) as defined above, component (b)(i) or (b)(ii) or a mixture thereof as defined above, and wherein the additional monomer is component (d) defined as from about 0.5% to about 25%, on a weight basis, of one or more monomers selected from the group consisting of: styrene, methyl-substituted styrene, chloromethyl-substituted styrene, 2-hydroxyethyl (meth)acrylate, ethylenediol di(meth)acrylate, N-methyloyl (meth)acrylamide, C₁-C₅ alkyl (meth)acrylate, and compounds of formula (III):

R⁴(OCH₂CH₂)ₘO—C(O)—C(R)═CH₂ (III)

wherein
m is 2 to about 10;
R⁴ is hydrogen, a C₁ to C₄ alkyl, or CH₂═C(R)C(O)—O—; and

each R is independently hydrogen, Cl, F or CH₃. Of the foregoing, 2-hydroxyethyl (meth)acrylate, ethylenediol di(meth)acrylate, N-methyloyl (meth)acrylamide, and compounds of formula (III) wherein m is 4 to 10 and R⁵ is hydrogen are most preferred. Preferably component (d) comprises about 3% to about 10% on a weight basis, of the copolymer formulation.

Another preferred embodiment of the present invention comprises a copolymer composition comprising component (a) as defined above, component (b)(i) or (b)(ii) or a mixture thereof as defined above, and wherein the additional monomers are component (c) and component (d), each as defined above. A preferred composition comprises component (a), component (b)(i), component (c), and component (d). The same preferences expressed above for component (d) are applicable in this embodiment.

Another embodiment of the present invention comprises a copolymer composition comprising component (a) as defined above, component (b)(i) or (b)(ii) or a mixture thereof as defined above, optionally component (c) as defined above; and further comprising component (e) which is from about 0.5% to about 10% of one or more monomers of formula (IVa), (IVb) or (IVc) as defined above. Preferably component (e) comprises from about 0.5% to about 3% on a weight basis, of the copolymer formulation.

In all of the embodiments of the present invention the percentages by weight of the monomers that are copolymerized to form the copolymer are chosen so that 1) the weight percent for each is within the range disclosed above, and 2) the total of the weight percents of the monomers adds up to 100%. Thus when optional monomers (c), (d), and/or (e) are present, the amounts (weight percents) of monomers (a) and/or (b) must be adjusted within the stated ranges for each to accommodate the presence of the optional monomers. For example, if monomer (c) is present at 1% by weight, the amount of monomer (a) and monomer (b) present will be chosen to add up to 99%, so that the total of monomers (a) plus (b) plus (c) is equal to 100%. For another example, if monomer (c) is present at 5%, monomer (d) is present at 18%, and monomer (e) is present at 7%, then the amount of monomer (a) and monomer (b) are chosen to add up to [100%−(5%+18%+7%)]=70%, so that the total of monomers (a) plus (b) plus (c) plus (d) plus (e) is equal to 100%. One skilled in the art can easily choose weight percentages for each monomer within the stated ranges so that the total equals 100%.

Emulsion polymerization can be employed to prepare the copolymer compositions of the invention. The polymerization is carried out in a reactor fitted with a stirrer and external means for heating and cooling the charge. The monomers to be polymerized together are emulsified in an aqueous solution containing a suitable surfactant, and optionally an organic solvent, to provide an emulsion concentration of 5% to 50% by weight. Typically volatile monomers, such as vinyl chloride and vinylidene chloride, are added directly to the reactor and not pre-emulsified. The temperature is raised to about 40 ° C. to about 70° C. to effect polymerization in the presence of an added catalyst. A suitable catalyst is any of the commonly known agents for initiating the polymerization of an ethylenically unsaturated compound. Such commonly employed initiators include 2,2′-azodi-isobutyramidine dihydrochloride; 2,2′-azodiisobutyro-nitrile; 2,2′-azobis(2-methylpropionamidine) dihydrochloride and 2,2′ azobis(2,4-dimethyl-4-methoxyvaleronitrile. The concentration of added initiator is usually 0.1 to about 2 weight percent, based on the weight of the mionomers to be polymerized. To control molecular weight of the resulting polymer, small amounts of a chain-transfer agent, such as an alkylthiol of 4 to about 18 carbon atoms, is optionally present during polymerization.

The surfactants used in this invention are any of those cationic, anionic and nonionic surfactants commonly used for preparing aqueous emulsions. Suitable cationic agents include, for example, dodecyltrimethylammonium acetate, trimethyltetradecylammonium chloride, hexadecyltrimethylammonium bromide, trimethyloctadecylammonium chloride, ethoxylated alkyl amine salts, and others. A preferred example of a suitable cationic surfactant is the methyl chloride salt of an ethoxylated alkyl amine salt such as an 18-carbon alkylamine with 15 moles of ethylene oxide such as ETHOQUAD 18/25 available from Akzo Nobel, Chicago, Ill. Nonionic surfactants which are suitable for use herein include condensation products of ethylene oxide with 12-18 carbon atom fatty alcohols, 12-18 carbon fatty acids, alkyl phenols having 8-18 carbon atoms in the alkyl group, 12-18 carbon atom alkyl thiols and 12-18 carbon atom alkyl amines. A preferred example of a suitable nonionic surfactant, if used in combination with the cationic surfactant, is an ethoxylated tridecyl alcohol surfactant such as MERPOL SE available from Stepan Company, Northfield, Ill. Suitable anionic surfactants which are used herein include alkyl carboxylic acids and their salts, alkyl hydrogen sulfates and their salts, alkyl sulfonic acids and their salts, alkyl ethoxy sulfates and their salts, alpha olefin sulfonates, alkylamidoalkylene sulfonates, and the like. Generally preferred are those wherein the alkyl groups have 8-18 carbon atoms. Especially preferred is an alkyl sulfate sodium salt where the alkyl group averages about 12 carbons, such as SUPRALATE WAQE surfactant, available from Witco Corporation, Greenwich, Conn.

Alternatively, solution polymerization in a suitable organic solvent can be used to prepare the copolymer compositions of the invention. Solvents which can be used for the polymerization include, but are not limited to: ketones, for example, acetone, methyl ethyl ketone (MEK), and methyl isobutyl ketone (MIBK); alcohols, for example isopropanol; esters, for example butyl acetate; and ethers, for example, methyl t-butyl ether. The monomers to be polymerized together are charged to a reactor as described above, together with a solvent. Typically the total monomer concentration in the organic solvent or mixture of organic solvents can be from about 20% to about 70% by weight. The temperature is raised to about 60° C. to about 90° C. to effect polymerization in the presence of at least one initiator, used in a proportion of 0.1 to 2.0% relative to the total weight of monomers. Initiators useful to effect polymerization in solution include: peroxides, for example benzoyl peroxide and lauryl peroxide; and azoic compounds for example, 2,2′-azobisisobutyronitrile, and 2,2′-azobis(2-methylbutyronitrile). To control molecular weight, optionally a chain-transfer agent, such as an alkylthiol, described above, can be used.

The fluorinated acrylates and fluorinated thioacrylates of formula (I), useful in forming the compositions of the invention, are prepared from the corresponding fluorinated alcohols and fluorinated thiols by esterification with acrylic acid, methacrylic acid, 2-chloroacrylic acid or 2-fluoroacrylic acid using procedures as described in U.S. Pat. No. 3,282,905 and European Patent 1632542 A1. Alternatively, acrylate and methacrylate esters of formula (I) can be made from the corresponding nitrate esters according to the procedures disclosed in U.S. Pat. No. 3,890,376.

The fluorinated acrylamide(s) of formula (I) wherein Z is —NH— useful in forming the compositions of the invention, are prepared from the corresponding fluorinated amines by condensation with acrylic acid chloride, methacrylic acid chloride, 2-chloroacrylic acid chloride or 2-fluoroacrylic acid chloride in the presence of a base, for instance, triethylamine. Typically a nonhydroxylic hydrocarbon solvent such as toluene or xylenes or a halocarbon solvent such as dichloromethane is used in the condensation.

The alkyl (meth)acrylates and amino (meth)acrylates of formula (II) are commercially available from Aldrich Chemical Company, Milwaukee, Wis.

Fluorinated alcohols useful in forming fluorinated acrylates useful in the invention include the fluorinated telomer alcohols of formula (V):

R_{f}—(CH₂CF₂)_{q}(CH₂CH₂)ᵣ—OH (V)

wherein R_{f} is a linear or branched perfluoroalkyl group having 2 to 6 carbon atoms. These telomer alcohols are available by synthesis according to Scheme 1.

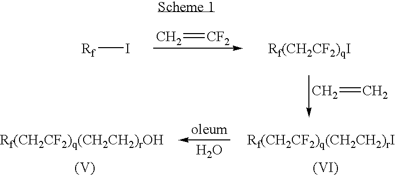

The telomerization of vinylidene fluoride with linear or branched perfluoroalkyl iodides produces compounds of the structure R_{f}(CH₂CF₂)_{q}I, wherein, q is 1 or more and R_{f} is a C₂ to C₆ perfluoroalkyl group. For example, see Balague, et al, “Synthesis of fluorinated telomers, Part 1, Telomerization of vinylidene fluoride with perfluoroalkyl iodides”, J. Fluorine Chem. (1995), 70(2), 215-23. The specific telomer iodides are isolated by fractional distillation. The telomer iodides are treated with ethylene by procedures described in U.S. Pat. No. 3,979,469 to provide the telomer ethylene iodides (VI) wherein r is 1 to 3 or more. The telomer ethylene iodides (VI) are treated with oleum and hydrolyzed to provide the corresponding telomer alcohols (V) according to procedures disclosed in WO 95/11877. Alternatively, the telomer ethylene iodides (VI) can be treated with N-methyl formamide followed by ethyl alcohol/acid hydrolysis.

The corresponding thiols of alcohols (V) are available from the telomer ethylene iodides (VI) by treatment with a variety of reagents according to procedures described in J. Fluorine Chemistry, 104, 2 173-183 (2000). One example is the reaction of the telomer ethylene iodides with sodium thioacetate, followed by hydrolysis, as shown in the following scheme:

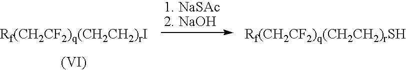

Specific fluorinated telomer alcohols (V) derived from telomerization of vinylidene fluoride and ethylene, and useful in forming fluorinated acrylates useful in the invention include those listed in Table 1A. The groups C₄F₉, and C₆F₁₃, referred to in the list of specific alcohols, in Tables 1A and 1B, and in the examples herein, refer to linear perfluoroalkyl groups unless specifically indicated otherwise.

TABLE 1A

| Compound No. | Structure |
|---|---|
| A1 | C₂F₅CH₂CF₂CH₂CH₂OH, |
| A2 | C₂F₅(CH₂CF₂)₂CH₂CH₂OH, |
| A3 | C₂F₅(CH₂CF₂)₃CH₂CH₂OH, |
| A4 | C₂F₅CH₂CF₂(CH₂CH₂)₂OH, |
| A5 | C₂F₅(CH₂CF₂)₂(CH₂CH₂)₂OH, |
| A6 | C₄F₉CH₂CF₂CH₂CH₂OH, |
| A7 | C₄F₉(CH₂CF₂)₂CH₂CH₂OH, |
| A8 | C₄F₉(CH₂CF₂)₃CH₂CH₂OH, |
| A9 | C₄F₉CH₂CF₂(CH₂CH₂)₂OH, |
| A10 | C₄F₉(CH₂CF₂)₂(CH₂CH₂)₂OH, |
| A11 | C₆F₁₃CH₂CF₂CH₂CH₂OH, |
| A12 | C₆F₁₃(CH₂CF₂)₂CH₂CH₂OH, |
| A13 | C₆F₁₃(CH₂CF₂)₃CH₂CH₂OH, |
| A14 | C₆F₁₃CH₂CF₂(CH₂CH₂)₂OH, |
| A15 | C₆F₁₃(CH₂CF₂)₂(CH₂CH₂)₂OH. |

Specific fluorinated telomer thiols derived from telomerization of vinylidene fluoride and ethylene and useful in the invention are listed in Table 1B.

TABLE 1B

| Compound No. | Structure |
|---|---|
| B1 | C₂F₅CH₂CF₂CH₂CH₂SH, |
| B2 | C₂F₅(CH₂CF₂)₂CH₂CH₂SH, |
| B3 | C₂F₅(CH₂CF₂)₃CH₂CH₂SH, |
| B4 | C₂F₅CH₂CF₂(CH₂CH₂)₂SH, |
| B5 | C₂F₅(CH₂CF₂)₂(CH₂CH₂)₂SH, |
| B6 | C₄F₉CH₂CF₂CH₂CH₂SH, |
| B7 | C₄F₉(CH₂CF₂)₂CH₂CH₂SH, |
| B8 | C₄F₉(CH₂CF₂)₃CH₂CH₂SH, |
| B9 | C₄F₉CH₂CF₂(CH₂CH₂)₂SH, |
| B10 | C₄F₉(CH₂CF₂)₂(CH₂CH₂)₂SH, |
| B11 | C₆F₁₃CH₂CF₂CH₂CH₂SH, |
| B12 | C₆F₁₃(CH₂CF₂)₂CH₂CH₂SH, |
| B13 | C₆F₁₃(CH₂CF₂)₃CH₂CH₂SH, |
| B14 | C₆F₁₃CH₂CF₂(CH₂CH₂)₂SH, |
| B15 | C₆F₁₃(CH₂CF₂)₂(CH₂CH₂)₂SH. |

The present invention further comprises a method of treating a substrate to impart oil repellency; water repellency and stain resistance comprising contacting the substrate with a copolymer composition of the invention as previously defined. The composition of the invention is applied directly to a substrate. The composition is applied alone or in admixture with dilute nonfluorinated polymers, or with other treatment agents or finishes. The composition can be applied at a manufacturing facility, retailer location, or prior to installation and use, or at a consumer location.

The copolymer composition of the present invention can be used as an additive during the manufacture of substrates. It is added at any suitable point during manufacture. For example, in the case of paper, the copolymer is added to the paper pulp in a size press. Preferably, from about 0.3% to about 0.5% by weight of the composition of the invention is added to paper pulp, based on the dry solids of the composition and dry paper fiber.

The composition of the present invention is generally applied to hard surface substrates by contacting the substrate with the composition by conventional means, including, but not limited to, brush, spray, roller, doctor blade, wipe, immersion, dip techniques, foam, liquid injection, and casting. Optionally, more than one coat can be applied, particularly on porous surfaces. When used on stone, tile and other hard surfaces, the compositions of the invention are typically diluted with water to give an application solution having from about 0. 1% by weight to about 20% by weight, preferably from about 1.0% by weight to about 10% by weight, and most preferably from about 2.0% by weight to about 5.0% by weight, of the composition based on solids. The coverage as applied to a substrate is about 100 g of application solution per sq meter (g/m²) for semi-porous substrates (e.g. limestone) and about 200 g/m² for porous substrates (e.g. Saltillo). Preferably the application results in from about 0.1 g/m² to about 2.0 g/m² of solids being applied to the surface.

The compositions of the invention are generally applied to fibrous substrates, such as nonwovens, fabrics, and fabric blends, as aqueous emulsions, dispersions, or solutions by spraying, dipping, padding, or other well-known methods. The copolymers of the invention are generally diluted with water to concentrations of about 5 g/L to about 100 g/L, preferably about 10 g/L to about 50 g/L, based upon the weight of the fully formulated emulsion. After excess liquid has been removed, for example by squeeze rolls, the treated fabric is dried and then cured by heating, for example, to 110° C. to 190° C., for at least 30 seconds, typically from about 60 to about 180 seconds. Such curing enhances repellency and durability. While these curing conditions are typical, some commercial apparatus may operate outside these ranges because of its specific design features.

The present invention further comprises substrates having contacted compositions of the invention, as described above. Substrates useful in the methods of the invention include hard surface substrates and fibrous substrates. Preferred substrates, having contacted compositions of the invention, have fluorine contents of from about 0.05% by weight to about 0.5% by weight.

Hard surface substrates include porous and non-porous mineral surfaces, such as glass, stone, masonry, concrete, unglazed tile, brick, porous clay and various other substrates with surface porosity. Specific examples of such substrates include unglazed concrete, brick, tile, stone including granite, limestone and marble, grout, mortar, statuary, monuments, composite materials such as terrazzo, and wall and ceiling panels including those fabricated with gypsum board.

Fibrous substrates include textiles, nonwovens, fabrics, fabric blends, carpet, wood, paper and leather. Textiles and fabrics comprise polyamides including but not limited to polyamide-6,6 (PA-66), polyamide-6 (PA-6), and polyamide-6,10 (PA-610), polyesters including but not limited to polyethylene terephthalate (PET), polytrimethylene terephthalate, and polybutylene terephthalate (PBT); rayon; cotton; wool; silk; hemp; and combinations thereof. Nonwoven materials include fibers of glass, paper, cellulose acetate and nitrate, polyamides, polyesters, polyolefins including bonded polyethylene (PE) and polypropylene (PP), and combinations thereof. Specific nonwovens include, for instance, polyolefins including PE and PP such as TYVEK (flash spun PE fiber), SONTARA (nonwoven polyester), and XAVAN (nonwoven PP), SUPREL, a nonwoven spunbond-meltblown-spunbond (SMS) composite sheet comprising multiple layers of sheath-core bicomponent melt spun fibers and side-by-side bicomponent meltblown fibers, such as described in U.S. Pat. No. 6,548,431, U.S. Pat. No. 6,797,655 and U.S. Pat. No. 6,831,025, all trademarked products of E. I. du Pont de Nemours and Company; nonwoven composite sheets comprising sheath-core bicomponent melt spun fibers, such as described in U.S. Pat. No. 5,885,909; other multi-layer SMS nonwovens that are known in the art, such as PP spunbond-PP meltblown-PP spunbond laminates; nonwoven glass fiber media that are known in the art and as described in U.S. Pat. No. 3,338,825, U.S. Pat. No. 3,253,978, and references cited therein; and KOLON (spunbond polyester) a trademarked product of Korea Vilene, Seoul, South Korea. The nonwoven materials include those formed by web forming processing including dry laid (carded or air laid), wet laid, spunbonded and melt blown. The nonwoven web can be bonded with a resin, thermally bonded, solvent bonded, needle punched, spun-laced, or stitch-bonded. The bicomponent melt spun fibers, referred to above, can have a sheath of PE and a core of polyester. If a composite sheet comprising multiple layers is used, the bicomponent melt-blown fibers can have a polyethylene component and a polyester component and be arranged side-by-side along the length thereof. Typically, the side-by-side and the sheath/core bicomponent fibers are separate layers in the multiple layer arrangement.

Preferred fibrous substrates for practicing the method of the invention include one or more materials selected from the group consisting of cotton, rayon, silk, wool, hemp, polyester, spandex, polypropylene, polyolefin, polyamide, aramid, and blends or combinations thereof. Preferred nonwovens comprise paper, cellulose acetate and nitrate, polyamides, polyesters, polyolefins, and combinations thereof. Most preferred nonwoven are bonded polyethylene, polypropylene, polyester, and combinations thereof.

The compositions and methods of the present invention are useful to provide one or more of excellent water repellency, oil repellency, and stain resistance to treated substrates. The compositions of the present invention allow for the use of shorter fluoroalkyl groups containing 6 or fewer fluorinated carbon atoms while conventional commercially available surface treatment products typically have 8 or more fluorinated carbon atoms.

### Materials and Test Methods

The following materials and test methods were use in the examples herein.

### Test Method 1—Oil and Water Repellency Test for Woven Fabrics

### A. Fabric Treatment

The woven fabrics used were 100% cotton, available from Textile Innovators Corporation, 100 Forest Street, Windsor, N.C. 27983; and 100% Nylon and 100% polyester available from Burlington Mills, Burlington Industries, Inc., Hurt, Va., 24563. The prepared concentrated dispersion of the polymer emulsions of the invention were diluted with deionized water to achieve a bath having 3% by weight of the final copolymer emulsion to be tested in the bath to achieve a weight % fluorine designated in Tables 8 and 9. The fabric was dipped in the bath, held there for 10 seconds, and removed. The fabric was dried at room temperature (RT) overnight and cured at approximately 160° C. for 3 minutes and allowed to cool to RT.

### B. Water Repellency Test

The water repellency of a woven fabric substrate was measured according to AATCC standard Test Method No. 193-2004 and the DuPont Technical Laboratory Method as outlined in the TEFLON Global Specifications and Quality Control Tests information packet. The test determines the resistance of a treated substrate to wetting by aqueous liquids. Drops of water-alcohol mixtures of varying surface tensions are placed on the substrate and the extent of surface wetting is determined visually. The higher the water repellency rating, the better the repellency of a finished fabric to water-based substances. The composition of water repellency test liquids is shown in Table 2.

TABLE 2
Water Repellency Test Liquids

| | |
|---|---|
| Water repellency | Composition, volume % |

| rating number | Isopropyl alcohol | Distilled water |
|---|---|---|
| 1 | 2 | 98 |
| 2 | 5 | 95 |
| 3 | 10 | 90 |
| 4 | 20 | 80 |
| 5 | 30 | 70 |
| 6 | 40 | 60 |
| 7 | 50 | 50 |
| 8 | 60 | 40 |
| 9 | 70 | 30 |
| 10 | 80 | 20 |
| 11 | 90 | 10 |
| 12 | 100 | 0 |

### C. Oil Repellency Test:

A series of organic liquids, identified below in Table 3, were applied dropwise to the fabric samples. Beginning with the lowest numbered test liquid (Repellency Rating No. 1), one drop (approximately 5 mm in diameter or 0.05 mL volume) was placed on each of three locations at least 5 mm apart. The drops were observed for 30 seconds. If, at the end of this period, two of the three drops were still spherical in shape with no wicking around the drops, three drops of the next highest numbered liquid was placed on adjacent sites and similarly observed for 30 seconds. The procedure was continued until one of the test liquids resulted in two of the three drops failing to remain spherical to hemispherical, or wetting or wicking occurred.

The oil repellency rating of the fabric was the highest numbered test liquid for which two of the three drops remained spherical to hemispherical, with no wicking for 30 seconds. In general, treated fabrics with a rating of 5 or more were considered good to excellent. Fabrics having a rating of one or greater can be used in certain applications.

TABLE 3
Oil Repellency Test Liquids

| Oil Repellency | |
|---|---|
| Rating Number | Test Solution |
| 1 | NUJOL^{a} purified mineral oil |
| 2 | 65/35 NUJOL/n-hexadecane by volume at 21° C. |
| 3 | n-hexadecane |
| 4 | n-tetradecane |
| 5 | n-dodecane |
| 6 | n-decane |
| 7 | n-octane |
| 8 | n-heptane |

^{a}NUJOL is a trademark of Plough, Inc., for a mineral oil having a Sayboltviscosity of 360/390 at 38° C. and a specific gravity of 0.880/0.900 at 15° C.

### Test Method 2—Repellency of Nonwoven Fabrics

### A. Fabric Treatment

The nonwoven fabrics used were SONTARA polyester-cellulosic nonwoven fabric, (74 g/m²) from DuPont, Nashville, Tenn.; and 100% spunbonded-melt blown-spunbonded nonwoven polypropylene fabric (SMS PP, 39 g/m²), manufactured by Kimberly-Clark, Roswell, Ga. Nonwoven fabrics were treated as described in Example 11 to 15 using a pad dipping process. The wet pick-up % for the SONTARA fabric was about 92%. After application of the dispersions, the treated SONTARA fabric was dried and cured in an oven until the fabric reached 250° F. (120° C.) and remained at that temperature for 3 minutes. The wet pick-up % for the SMS PP nonwoven fabric was about 142%. After pad application, the treated SMS PP fabric was dried and cured in an oven until the fabric reached 220° F. (105° C.) and remained at that temperature for 3 minutes. The treated fabrics were allowed to “rest” after treatment and cure. The treated fabrics were conditioned according to ASTM D1776 for a minimum of 4 hours prior to testing.

### B. Alcohol Repellency of Nonwoven Fabrics

Treated nonwoven fabrics were tested for alcohol repellency using the INDA Standard Test Method for Alcohol Repellency of Nonwoven Fabrics 80.6-92. Drops of standard test liquids, consisting of a series of water/alcohol solutions, listed in Table 3A, were placed on the test material and observed for penetration or wetting. Beginning with the lowest numbered test liquid (Alcohol Repellency Rating No. 0), a small drop, approximately 5 mm in diameter or 0.05 mL volume, was placed on the test specimen in at least 3 locations. After 5 min, the specimen was observed for penetration. A non-penetrating drop was indicated by a spherical drop having a high contact angle, and no darkening of the reverse side of the specimen when inverted. If no penetration of the test specimen occurred, drops of the next higher numbered test liquid were placed on the specimen at different sites, and again observed after 5 minutes for penetration. The alcohol rating was the highest numbered test liquid that did not penetrate the fabric.

TABLE 3A
Alcohol Repellency Standard Test Liquids

| Alcohol repellency | Composition, wt % | Wt % |
|---|---|---|
| rating number | Alcohol^{a} | distilled water |
| 0 | 0 | 100 |
| 1 | 10 | 90 |
| 2 | 20 | 80 |
| 3 | 30 | 70 |
| 4 | 40 | 60 |
| 5 | 50 | 50 |
| 6 | 60 | 40 |
| 7 | 70 | 30 |
| 8 | 80 | 20 |
| 9 | 90 | 10 |
| 10 | 100 | 0 |

^{a}isopropyl alcohol was used.

### C. Penetration by Water (Spray Impact Test) of Nonwoven Fabrics

The treated nonwoven fabrics were tested for penetration by water using the INDA Standard Test Method for Penetration by Water (Spray Impact Test) of Nonwoven Fabrics 80.3-92. The method measures the resistance of nonwoven fabrics to the penetration of water by impact and can be used to predict the probable rain penetration resistance of the nonwoven fabric. The sample was used as protective barrier covering a sheet of preweighed, absorbent blotting paper (conforming to US Federal Specification NNN-P-035, available from AATCC, Research Triangle Park, N.C. 27709). A specific volume of DI water (500 mL, 27±1° C.) was gravity fed through a spray nozzle onto a 45 degree inclined sample centered 24 inches (60.7 cm) below the spray nozzle; and the blotter weighted again. The difference in the two weights was a measure of the amount of water passing through the nonwoven fabric barrier. The greater the difference, the more water that has passed through; i.e., the less water repellent the fabric. Thus, higher numbers indicate lower water repellency.

### Test Method 3—Determination of Water and Oil Repellency on Hard Surfaces

This test method describes the procedure for testing water repellency on hard surface substrates including limestone, concrete, granite, and saltillo. Square tiles of 12 inch square (30.5 cm²) of a sample limestone (Euro Beige), and granite (White cashmere) were cut into 4 inch (10.2 cm) by 12 inch (30.5 cm) samples. Concrete bricks employed were 7.5 inch (19 cm) by 3.5 inch (9 cm), and saltillo pavers employed were 12-inch square (30.5 cm²) were employed. After cutting, the samples were rinsed to remove any dust or dirt and allowed to dry thoroughly, typically for at least 24 hours. A penetrating solution was prepared by mixing a composition of the present invention with solvent, with mixing, to provide a fluorine concentration of 0.8% fluorine by weight. A ½-inch (1.3 cm) paintbrush was used to apply the solution to samples of each substrate surface. The surface was then allowed to dry for fifteen minutes. If necessary, the surface was wiped with a cloth soaked in the treating solution to remove any excess. After the treated substrates dried overnight, three drops of deionized water and three drops of Canola oil were placed on each substrate and allowed to sit for five minutes. Visual contact angle measurements were used to determine water and oil repellency. The following rating chart was used to determine contact angle using a 0 to 5 scale, as shown below:
Repellency Rating 5 (Excellent): Contact angle 100°-120°.
Repellency Rating 4 (Very good): Contact angle 75°-90°.
Repellency Rating 3 (Good): Contact angle 45°-75°.
Repellency Rating 2 (Fair): Contact angle 25°-45°.
Repellency Rating 1 (Poor): Contact angle 10°-25°.
Repellency Rating 0 (Penetration): Contact angle <10°.

Higher numbers indicate greater repellency with ratings of 2 to 5 being acceptable. The data is reported in the tables as water beading and oil beading.

### Test Method 4—Determination of Stain Resistance

Stain resistance was determined on limestone, concrete and Saltillo substrates using this method. Square tiles of 12 inch square (30.5 cm²) of a sample limestone (Euro Beige) were cut into 4 inch (10.2 cm) by 12 inch (30.5 cm) samples. Concrete bricks employed were 7.5 inch (19 cm) by 3.5 inch (9 cm), and saltillo pavers employed were 12-inch square (30.5 cm²) were employed. After cutting, the samples were rinsed to remove any dust or dirt and allowed to dry thoroughly, typically for at least 24 hours. A. penetrating solution was prepared by mixing the composition of the present invention with solvent to provide a concentration of 0.8% fluorine by weight. A ½-inch (1.3 cm) paintbrush was used to apply the solution to samples of each substrate surface. The surface was then allowed to dry for fifteen minutes. If necessary, the surface was wiped with a cloth soaked in the treating solution to remove any excess. After the treated substrates dried overnight, the following food stains were placed at intervals on the surface of the substrate: 1) hot bacon grease, 2) cola, 3) black coffee, 4) grape juice, 5) Italian salad dressing, 6) ketchup, 7) lemon juice, 8) mustard, 9) canola oil and 10) motor oil. After a 24-hour period, the food stains were blotted or lightly scraped from the substrate surface. The substrate's surface was rinsed with water and a 1% soap solution, and a stiff bristle brush was used to scrub the surface 10 cycles back and forth. The substrates were then rinsed with water and allowed to dry for 24 hours before rating.

The stains remaining on the tile surfaces after cleaning were rated visually according to a scale of 0 to 4 as follows: 0=no stain; 1=very light stain; 2=light stain; 3=moderate stain; and 4=heavy stain. The ratings for each substrate type are summed for each of the stains to give a composite rating for each type. The maximum total score for one substrate was 10 stains times the maximum score of 4=40. Lower scores indicated better stain protection, with scores of 20 or less being acceptable and with zero indicating the best protection with no stain present.

### Test Method 5—Contact Angle Measurement

Contact angles are measured by the Sessile Drop Method, which is described by A. W. Adamson in The Physical Chemistry of Surfaces, Fifth Edition, Wiley & Sons, New York, N.Y., 1990. Additional information on the equipment and procedure for measuring contact angles is provided by R. H. Dettre et al. in “Wettability”, Ed. by J. C. Berg, Marcel Dekker, New York, N.Y., 1993.

Contact angle (CA) measurements to determine the water and hexadecane contact angles on a sample surface were performed using a Ramé-Hart Standard Automated Goniometer (Model 200, available from Ramé-Hart Inc., 43 Bloomfield Ave, Mountain Lakes, N.J.) employing DROPIMAGE standard software and equipped with an automated dispensing system. To determine the contact angle of the test fluid on the sample, the sessile drop method was used. Films were prepared by spin-coating the as-prepared emulsions onto MYLAR film substrates at 1000 rpm for 30 seconds. Films were thermally annealed in a 160° C. oven for 5 minutes and then air-dried for 24 hours. Approximately one drop of test fluid was dispensed onto the sample using an automated dispensing pump to dispense a calibrated amount of the test fluid. For water measurements, deionized water was employed, and for oil measurements, hexadecane was suitably employed. The advancing angle is the contact angle when the three phase line is advanced over the surface. The contact angle was measured at a prescribed temperature with a telescoping goniometer from the same manufacturer. A drop of test liquid was placed on a polyester film substrate and the tangent was precisely determined at the point of contact between the drop and the surface. An advancing angle was determined by increasing the size of the drop of liquid and a receding angle was determined by decreasing the size of the drop of liquid. The data are presented typically as advancing and receding contact angles.

The relationship between water and organic liquid contact angles and the cleanability and dirt retention of surfaces is described by A. W. Adamson, cited above. In general, higher hexadecane contact angles indicate that a surface has greater dirt and soil repellency, and easier surface cleanability.

### Test Method 6—Oil Repellency for Paper

The oil repellency of paper treated with the copolymer compositions of the invention was tested following the TAPPI 557 method using 16 solutions in the kit test that have different concentrations of castor oil, toluene, and n-heptane. The solutions discriminate the various oleo-repellent treatment levels and therefore can be used to assign respective kit test values that are essentially a function of the surface tension which ranges from 34.5 dyne/cm of the solution 1, to 22 dyne/cm of the solution 12, to 20.3 dyne/cm of the solution 16. Animal or vegetable fats have a surface tension not lower than 24 dyne/cm which corresponds to a kit test value of about 7.

A kit test value was assigned to the treated paper by means of the following procedure. A paper sample was placed on a clean flat, black-colored surface and a drop of the solution 1 is let fall thereon from a height of 22 mm. The drop was left in contact with the paper for 15 sec, and then removed by clean blotting paper, and the surface under the drop examined. If the surface under the drop did not appear dark, for instance, no halo, the test was repeated using a solution having a lower surface tension, until the presence of a dark halo was observed. Higher test values indicate a higher oil-repellency for the paper sample.

### Materials

Table 4 is a list of materials, with abbreviations or trademark, used in the examples.

TABLE 4
Materials

| Descriptor | Generic name/structure | Source |
|---|---|---|
| ARMEEN | Octadecylamine | Akzo Nobel, Chicago, IL |
| DM18D | | |
| AVITEX R | cationic alkyl amine | E. I. du Pont de Nemours |
| | | and Company, Wilmington, DE |
| DDM | dodecyl mercaptan | Aldrich Chemical Co., Milwaukee, WI |
| DPG | dipropylene glycol | Aldrich Chemical Co., Milwaukee, WI |
| ETHOX | tridecyl alcohol 5- | Ethox Chemicals, Greenville, SC |
| TDA-5 | ethylene oxide adduct | |
| ETHOQUAD | methyl | Akzo Nobel, Chicago, IL |
| 18/25 | poly(oxyethylene)-15 | |
| | octadecyl ammonium chloride | |
| 7-EO | poly(oxyethylene)-7 | NOF America, White Plains, NY |
| methacrylate | methacrylate | |
| FREEPEL | emulsified wax | Noveon Inc. Cleveland, OH. |
| 1225 | | |
| HEMA | 2-hydroxyethyl | Aldrich Chemical Co, Milwaukee, WI |
| | methacrylate | |
| MAM | N-methylol acrylamide | Aldrich Chemical Co., Milwaukee, WI |
| MAPEG | polyethylene glycol | BASF, Lugwigshafen, Germany |
| 600MS | 600 monostearate | |
| MIBK | methyl isobutyl ketone | Aldrich Chemical Co., Milwaukee, WI |
| SUPRALATE | sodium alkyl sulfate | Witco Corporation, Greenwich, CN |
| WAQE | mixture | |
| VAZO 56 | 2,2′-azobis(2- | E. I. du Pont de Nemours |
| WSP | methylpropionamidine) | and Company, Wilmington, DE |
| | dihydrochloride | |
| VAZO 64 | 2,2′- | E. I. du Pont de Nemours |
| | azobisisobutyronitrile | and Company, Wilmington, DE |
| VAZO 67 | 2,2′-azobis(2- | E. I. du Pont de Nemours |
| | methylbutyronitrile) | and Company, Wilmington, DE |
| ZELEC TY R | antistatic agent | E. I. du Pont de Nemours |
| | | and Company, Wilmington, DE |

Compounds A1 through A15 refer to the fluoroalcohols listed in Table 1A and were prepared as follows.

### Compound A6

C₄F₉CH₂CF₂CH₂CH₂OH

Ethylene (25 g) was introduced to an autoclave charged with C₄F₉CH₂CF₂I (217 g) and d-(+)-limonene (1 g), and the reactor heated at 240° C. for 12 hours. The product was isolated by vacuum distillation to provide C₄F₉CH₂CF₂CH₂CH₂I. Fuming sulfuric acid (70 mL) was added slowly to 50 g of C₄F₉CH₂CF₂CH₂CH₂I and mixture was stirred at 60° C. for 1.5 hours. The reaction was quenched with ice-cold 1.5 wt % Na₂SO₃ aqueous solution and heated at 95° C. for 0.5 hours. The bottom layer was separated and washed with 10 wt % aqueous sodium acetate and distilled to provide C₄F₉CH₂CF₂CH₂CH₂OH (compound A6): bp 54-57° C. at 2 mmHg (267 Pascals).

Compound A6-acrylate

C₄F₉CH₂CF₂CH₂CH₂O—C(O)—CH═CH₂

p-Toluene sulfonic acid (p-TSA, 2.82 g, 0.0148 mol), methylhydroquinone (MEHQ, 420 mg), compound A6 (120 g) and cyclohexane (121 mL) were combined in a flask equipped with Dean Stark trap. The reaction mixture was heated to 85° C., acrylic acid (31.3 mL) was added, and-heating continued for 24 hours. The Dean Stark trap was replaced with a short path distillation column, deionized (DI) water was added to the reaction mixture, followed by distillation of cyclohexane. The reaction mixture was cooled to about 50° C. The bottom layer was placed in a separatory funnel, washed with 10% sodium bicarbonate solution, dried over anhydrous MgSO₄, and the solvent evaporated under reduced pressure to provide compound A6-acylate (134 g, 95% yield): ¹H NMR (CDCl₃, 400 MHz) 6.42 (1H, d-d, J1=17.3 Hz, J2=1.4 Hz), 6.1 (1H, d-d, J1=17.3 Hz, J2=10.5 Hz), 5.87 (1H, d-d, J1=10.5 Hz, J2=1.4 Hz), 4.41 (2H, t, J=6.4 Hz), 2.86-2.48 (2H, m), 2.42 (2H, t-t, J1=16.7 Hz, J2=6.0 Hz); MS: 383 (M⁺+1).

Compound A6-methacrylate

C₄F₉CH₂CF₂CH₂CH₂O—C(O)—C(CH₃)═CH₂

Compound A6 was treated with methacrylic acid in a similar manner as described above for the compound A6-acrylate formation to provide compound A6-methacrylate: (130 g, 89% yield): bp 47-50° C. at 0.4 mm Hg (53 Pascals); ¹H NMR (CDCl₃, 400 MHz): 6.10 (1H, m), 5.59 (1H, m), 4.39 (2H, t, J=6.0 Hz), 2.85-2.69 (2H, m), 2.43 (2H, t-t, J1=16.5 Hz, J2=6 Hz), 1.94 (3H, m); MS: 397 (M⁺+1).

### Compound A7

C₄F₉(CH₂CF₂)₂CH₂CH₂OH

Ethylene (56 g) was introduced to an autoclave charged with C₄F₉(CH₂CF₂)₂I (714 g) and d-(+)-limonene (3.2 g), and the reactor heated at 240° C. for 12 hours. The product was isolated by vacuum distillation to provide C₄F₉(CH₂CF₂)₂CH₂CH₂I. A mixture of C₄F₉(CH₂CF₂)₂CH₂CH₂I (10 g, 0.02 mol) and N-methylformamide (8.9 mL, 0.15 mol) was heated to 150° C. for 26 hours. The mixture was cooled to 100° C., followed by the addition of water to separate the crude ester. Ethyl alcohol (3 mL) and p-toluene sulfonic acid (0.09 g) were added and the mixture stirred at 70° C. for 0.25 hours. Ethyl formate and ethyl alcohol were removed by distillation to give a crude product. The crude product was dissolved in ether, washed with 10 wt % aqueous sodium sulfite, water and brine, in turn, and dried over magnesium sulfate. Distillation provided the product (6.5 g, 83% yield): bp 94-95° C. at 2 mm Hg (266 Pascals).

### Compound A7 Acrylate

C₄F₉(CH₂CF₂)₂CH₂CH₂O—C(O)—CH═CH₂

A mixture of p-toluene sulfonic acid, (0.29 g), methylhydroquinone, (0.043 g) and C₄F₉(CH₂CF₂)₂CH₂CH₂OH (15 g, 0.038 mol) in cyclohexane (12.5 mL), in flask equipped with a Dean Stark trap, was heated to 85° C., followed by addition of acrylic acid (3.3 mL, 0.048 mol). After 24 h, the Dean Stark trap was replaced with a short path distillation column. Deionized water (15 mL) was added to the reaction mixture, followed by distillation of the cyclohexane. The reaction mixture was cooled to about 50° C. The bottom layer was placed in a separatory funnel, washed with 10% sodium bicarbonate solution, dried over anhydrous MgSO₄, and the solvent evaporated under reduced pressure, to provide Compound A7 acrylate (15 g, 90% yield): ¹H NMR (CDCl₃ , 400 MHz): 6.44 (1H, d-d, J1=17.3 Hz, J2=1.4 Hz), 6.11 (1H, d-d, J1=17.3 Hz, J2=10.5 Hz), 5.86 (1H, d-d, J1=10.5 Hz, J2=1.4 Hz), 4.40 (2H, t, J=6.4 Hz), 2.94˜2.65 (4H, m), 2.38 (2H, t-t, J1=16.7 Hz, J2=6.0 Hz); MS: 447 (M+⁺1).

### Compound A7 Methacrylate

C₄F₉(CH₂CF₂)₂CH₂CH₂O—C(O)—C(CH₃)═CH₂

Compound A7 was treated with methacrylic acid in a similar manner as described above for the Compound A7-acrylate formation to provide Compound A7-methacrylate (16 g, 94% yield): ¹H NMR (CDCl₃, 400 MHz): 6.12-6.11 (1H, m), 5.60-5.59 (1H, m), 4.38 (2H, t, J=6.0 Hz), 2.94˜2.66 (4H, m), 2.38 (2H, t-t, J1=16.5 Hz, J2=6 Hz), 1.95-1.94 (3H, m); MS: 461 (M+⁺1).

### Compound A11

C₆F₁₃CH₂CF₂CH₂CH₂OH

Ethylene (15 g) was introduced to an autoclave charged with C₆F₁₃CH₂CF₂I (170 g) and d-(+)-limonene (1 g), and then the reactor was heated at 240° C. for 12 hours. Product was isolated by vacuum distillation to provide C₆F₁₃CH₂CF₂CH₂CH₂I. Fuming sulfuric acid (129 mL) was added slowly to C₆F₁₃CH₂CF₂CH₂CH₂I (112 g). The mixture was stirred at 60° C. for 1.5 hours. Then the reaction was quenched with ice-cold 1.5 wt % aqueous Na₂SO₃ and heated at 95° C. for 0.5 hours. The bottom layer was separated and washed with 10 wt % aqueous sodium acetate and distilled to provide Compound A11: mp 38° C.

Compound A11-acrylate

C₆F₁₃CH₂CF₂CH₂CH₂O—C(O)—CH═CH₂

p-Toluene sulfonic acid (1.07 g, 0.0056 mol), methylhydroquinone (160 mg), compound A11 (60 g, 0.14 mol) and cyclohexane (46 mL) were combined in a flask equipped with Dean Stark trap. The reaction mixture was heated to 85° C., acrylic acid (12 mL) was added and heating continued for 24 hours. The Dean Stark trap was replaced with a short path distillation column, deionized water was added and the cyclohexane distilled. The reaction mixture was cooled to about 50° C., transferred to a separatory funnel, and washed with 10% sodium bicarbonate solution, dried over anhydrous MgSO₄, and concentrated to provide Compound A11-acrylate (64 g, 95% yield): bp 55-57° C. at 0.2 mm Hg (26.6 Pascals); ¹H NMR (CDCl₃, 400 MHz): 6.42 (1H, d-d, J1=17.3 Hz, J2=1.4 Hz), 6.1 (1H, d-d, J1=17.3 Hz, J2=10.5 Hz), 5.87 (1H, d-d, J1=10.5 Hz, J2=1.4 Hz), 4.40 (2H, t, J=6.4 Hz), 2.86-2.48 (2H, m), 2.42 (2H, t-t, J1=16.7 Hz, J2=6.0 Hz); MS: 483 (M+⁺1).

Compound A 11-methacrylate

C₆F₁₃CH₂CF₂CH₂CH₂O—C(O)—C(CH₃)═CH₂

Compound A11 was treated with methacrylic acid in a similar manner as described above for the Compound A11-acrylate formation to provide Compound A11-methacrylate (62 g, 89% yield).

### Compound A12

C₆F₁₃(CH₂CF₂)₂CH₂CH₂OH

Ethylene (56 g) was introduced to an autoclave charged with C₆F₁₃(CH₂CF₂)₂I (714 g) and d-(+)-limonene (3.2 g), and the reactor heated at 240° C. for 12 hours. Product was isolated by vacuum distillation to provide C₆F₁₃(CH₂CF₂)₂CH₂CH₂I. The C₆F₁₃(CH₂CF₂)₂CH₂CH₂I (111 g) and N-methylformamide (81 mL) were heated to 150° C. for 26 hours. The reaction was cooled to 100° C., followed by the addition of water to separate the crude ester. Ethyl alcohol (21 mL) and p-toluene sulfonic acid (0.7 g) were added to the crude ester, and the reaction was stirred at 70° C. for 15 min. Ethyl formate and ethyl alcohol were removed by distillation and the resulting crude alcohol was dissolved in ether, washed with aqueous sodium sulfite, water, and brine in turn, and dried over magnesium sulfate. The product was distilled under vacuum to provide Compound A12: mp 42° C.

Compound A12-acrylate

C₆F₁₃(CH₂CF₂)₂CH₂CH₂O—C(O)—CH═CH₂

p-Toluene sulfonic acid (0.29 g), methylhydroquionone (0.043 g), Compound A12 (15 g, 0.031 mol), and cyclohexane (10 mL) were combined in a flask equipped with a Dean Stark trap. The reaction mixture was heated to 85° C., acrylic acid (2.6 mL, 0.038 mol) was added, and heating continued for 24 hours. The Dean Stark trap was replaced with a short path distillation column. Deionized water was added, and the cyclohexane distilled. The reaction mixture was cooled to about 50° C., the bottom layer transferred to a separatory funnel, washed with 10% sodium bicarbonate solution, dried over anhydrous MgSO₄, and concentrated to provide A12-acrylate (15.5 g, 93% yield).

Compound A12-methacrvlate

C₆F₁₃(CH₂CF₂)₂CH₂CH₂O—C(O)—C(CH₃)═CH₂

Compound A12 was treated with metharcylic acid in a similar manner as described above for the Compound A12-acrylate formation to provide Compound A12-methacylate (15.5 g, 91% yield).

### EXAMPLES

### Example 1-8

Examples 1-8 were prepared using the various fluorinated monomers listed in Table 5. A constant weight of various fluorinated monomers was used in Examples 1-8 to provide polymer emulsions. The compositions of the emulsions are listed in Tables 6 and 7.

TABLE 5
Fluorinated Monomers for Examples 1–8

| Example | Fluorinated Monomer |
|---|---|
| 1 | A6-acrylate |
| 2 | A7-acrylate |
| 3 | A11-acrylate |
| 4 | A12-acrylate |
| 5 | A6-methacrylate |
| 6 | A7-methacrylate |
| 7 | A11-methacrylate |
| 8 | A12-methacrylate |

TABLE 6
Emulsion Composition for Examples 1–4

| Material | Emulsion, g | |
|---|---|---|
| fluorinated monomer | 11.25 | |
| per Table 5 | | |
| 2-ethylhexyl acrylate | 3.75 | |
| N-methylol acrylamide | 0.3 | |
| 2-hydroxyethyl | 0.15 | |
| methacrylate | | |
| acetic acid | 0.45 | |
| ARMEEN DM 18D | 0.75 | g |
| octadecylamine | | |
| Deionized water | 35 | |

TABLE 7
Emulsion Composition for Examples 5–8

| Material | Emulsion, g | |
|---|---|---|
| fluorinated monomer | 11.25 | |
| per Table 5 | | |
| 2-ethylhexyl methacrylate | 3.75 | |
| N-methyl acrylamide | 0.3 | |
| 2-hydroxyethyl | 0.15 | |
| methacrylate | | |
| acetic acid | 0.45 | |
| ARMEEN DM 18D | 0.75 | g |
| octadecylamine | | |
| deionized water | 35 | |

Each emulsion composition was sonicated for about 3 min to provide an emulsion. The emulsion was transferred to a reactor, purged with nitrogen, and heated to 65° C. VAZO 56 WSP (0.75 g) in water (2.5 mL) was added to each emulsion and the emulsion stirred for 3 h at 65° C. The emulsions were cooled to RT to provide polymer emulsions (30 wt % solids). The various polymer emulsions were tested for oil and water repellency on nylon and cotton fabric.

### Comparative Example A

The procedure of Example 1 was employed, but using as the fluorochemical a mixture of acrylates the formula F(CF₂)_{b}CH₂CH₂O C(O)—C(H)═CH₂, wherein b ranged from 6 to 16, and was predominately 8 and 10. The typical mixture was as follows: 3% of b=6, 54% of b=8, 29% of b=10, 12% of b=12,3% of b=14 and 1% of b=16.

### Comparative Example B

The procedure of Example 1 was employed, but using as the as the fluorochemical mixture of methacrylates of formula F(CF₂)_{b}CH₂CH₂O C(O)—C(CH₃)═CH₂, wherein b ranged from 4 to 12, and was predominately 6, and 8. The typical mixture was as follows: 0.2% of b=4, 32.6% of b=6, 35% of b=8, 18.6% of b=10, 12.7% of b=12.

### Testing of Examples 1-8

The various polymer emulsions of Examples 1-8 were tested for oil and water repellency on nylon and cotton fabric according to Test Method 1. The results are listed in Tables 8 and 9 with untreated substrates as controls.

TABLE 8
Repellency Test Results of Polymer Based on Examples 1–4

| | |
|---|---|
| Cotton | Nylon |

| Example | F %^{a} | water | oil | water | oil |
|---|---|---|---|---|---|
| Control | 0 | 0 | 0 | 0 | 0 |
| 1 | 0.36 | 5 | 2 | 4 | 0 |
| 2 | 0.36 | 5 | 2 | 5 | 2 |
| 3 | 0.38 | 10 | 5 | 7 | 5 |
| 4 | 0.38 | 11 | 5 | 8 | 4 |
| Comparative A | 0.42 | 12 | 7 | 12 | 7 |

^{a}in the dipping bath.

TABLE 9
Repellency Test Results of Polymer Based on Examples 5–8

| | |
|---|---|
| Cotton | Nylon |

| Example | F %^{a} | water | oil | water | oil |
|---|---|---|---|---|---|
| Control | 0 | 0 | 0 | 0 | 0 |
| 5 | 0.34 | 5 | 1 | 6 | 1 |
| 6 | 0.34 | 5 | 1 | 6 | 2 |
| 7 | 0.38 | 11 | 4 | 10 | 5 |
| 8 | 0.38 | 10 | 5 | 11 | 4 |
| Comparative B | 0.4 | 11 | 5 | 9 | 4 |

^{a}in the dipping bath.

The data indicate that fabric treated with the copolymer compositions of Examples 1 to 8 showed good water repellency and oil repellency. Examples 7 and 8, having a perfluoroalkyl group with 6 carbon atoms, exhibited water repellency and oil repellency comparable to or better than the Comparative Example B having a perfluoroalkyl group predominately with 8 and 10 carbon atoms, at about the same fluorine levels.

The copolymer compositions of Examples 1-8 were further characterized by contact angle on polyester film substrates according to Test Method 5 described above. Advancing water and hexadecane contact angles were measured for each Example 1 to 8, the untreated controls, and Comparative Examples A and B. The results, listed in Table 10, showed the contact angles of all treated substrates were significantly higher than that of the untreated MYLAR control. More significantly, Examples 3, 4, 7 and 8 emulsions provided water and hexadecane contact angles comparable to, or higher than, the conventional Comparative Examples A and B comprising large fractions of eight carbon and higher perfluoroalkyl (meth)acrylates.

TABLE 10
Contact angles of polymer films

Advancing Contact Angle (°)

| Example No. | Water | Hexadecane |
|---|---|---|
| 1 | 111 ± 1 | 61 ± 1 |
| 2 | 118 ± 4 | 71 ± 1 |
| 3 | 125 ± 3 | 89 ± 4 |
| 4 | 136 ± 2 | 78 ± 4 |
| Comparative A | 122 ± 6 | 84 ± 2 |
| untreated | 86 ± 1 | 17 ± 2 |
| 5 | 103 ± 4 | 62 ± 1 |
| 6 | 109 ± 4 | 62 ± 1 |
| 7 | 118 ± 3 | 75 ± 2 |
| 8 | 126 ± 1 | 81 ± 5 |
| Comparative B | 115 ± 3 | 71 ± 1 |

### Example9

Sodium chloride (0.025 g), isopropyl alcohol (11.24 g), 2-(N,N-diethylamino)ethyl methacrylate (1.76 g), glycidyl methacrylate (0.29 g), A11-acrylate (8.20 g) and dodecyl mercaptan (0.02 g) were charged in a 250 mL flask, which was equipped with a condenser and stirrer. A solution of VAZO 67 (0.033 g) in isopropyl alcohol (2.5 g) was added dropwise to the flask. The mixture was stirred and purged with nitrogen for 1 h at 28° C. The temperature was then raised to 68° C. for 16 hours. The mixture was then cooled to 65° C. A mixture of acetic acid (0.6 g) and water (100 g) was added, converting the polymer to be a homogenous dispersion. During the dispersion stage, the acetic/water mixture was maintained at about 65° C. with agitation. The isopropyl alcohol was then removed by distillation to provide a polymer dispersion (13.91% solids).

### Oil Repellency for Paper

A bath was prepared containing about 4 parts by weight of starch (Penford GUM 280 corn starch) and about 94 parts by weight of water. The bath was heated to 90-100° C. for 0.75 h to dissolve the starch, cooled to about 85° C., and 2.5 parts by weight of the dispersion of Example 9 was added to provide a 2.49 wt % solution. The hot solution was then transferred to a pad bath of a lab paper size press. The bath was then applied to paper (38 lb standard weight) with a wet pick-up of about 79% at about 70° C. The treated paper was then dried on a laboratory drum dryer at 235 F (112° C.) for 25 seconds. The dried paper was then evaluated for oil repellency using Test Method 6—Oil Repellency for Paper. The results, listed in Table 11, indicated that the paper treated with the polymer dispersion of Example 9 exhibited significant oil repellency properties.

TABLE 11
Repellency Test Results on Paper

| | fluoropolymer in bath | |
|---|---|---|
| Example | wt % | Oil repellency |
| 9 | 0.35 | 7 |
| Control (untreated) | 0 | 0 |

### Example 10

VAZO 67 (0.047 g) dissolved in MIBK (0.47 g) was added to the mixture of 2-(N,N-diethylamino)ethyl methacrylate (3.2g), A11-methacylate (6.25 g), and MIBK (7.69 g) at 35° C., and the mixture heated at 70° C. over night. Water (19 g) and acetic acid (1.37 g) were added and the mixture was stirred at 70° C. for 0.5 hours. The MIBK was removed under reduced pressure to provide a polymer dispersion (30.88% solids). The dispersion was tested on stone and tile substrates for repellency and stain resistance.

A treating solution was prepared by adding the dispersion of Example 10 (1.01 g) to 14.0 g of deionized water to provide a 0.8% F dispersion. The 0.8% F dispersion was applied at about 0.40 g per substrate, or about 100 g/m², in treating limestone; and 0.44 g per substrate in treating granite substrates; according to Test Methods 3 and 4, defined above. The controls were untreated substrates. The results are listed in Tables 12 and 13. As discussed in Test Method 4, a lower staining rating is indicative of higher stain resistance. The polymer dispersion of Example 10 provided improved oil repellency and water repellency to the treated substrates, as well improved stain resistance.

TABLE 12
Limestone Repellency and Stain Test Results

| Food stains | Example 10 | Control |
|---|---|---|
| Coke | 1 | 2 |
| Mustard | 3 | 4 |
| Ketchup | 4 | 2 |
| Grape juice | 3 | 4 |
| Italian dressing | 1 | 4 |
| Coffee | 1 | 3 |
| Lemon Juice | 4 | 4 |
| Motor Oil | 3 | 4 |
| Canola Oil | 3 | 4 |
| Bacon Grease | 2 | 4 |
| Total | 25 | 35 |
| Water Beading | 4 | 1 |
| Oil Beading | 0.75 | 1 |

TABLE 13
Granite Repellency and Stain Test Results

| Food stains | Example 10 | Control |
|---|---|---|
| Coke | 0 | 2 |
| mustard | 0 | 3 |
| ketchup | 0 | 1 |
| grape juice | 2 | 4 |
| Italian dressing | 0 | 4 |
| Coffee | 0 | 3 |
| lemon Juice | 0 | 2 |
| motor oil | 0 | 4 |
| canola oil | 0 | 4 |
| bacon grease | 0 | 4 |
| total | 2 | 31 |
| water beading | 3 | 1 |
| oil beading | 2 | 1 |

### Examples 11-13

Examples 11-13 were prepared using the various fluorinated monomers listed in Table 14. A constant weight of the fluorinated monomers (11.6 g) was used to provide the polymer emulsions. The compositions of the emulsions are listed in Table 15.

TABLE 14
Fluorinated Monomers for Examples 11–13

| Example | Fluorinated Monomer |
|---|---|
| 11 | A11-methacylate |
| 12 | A12-methacrylate |
| 13 | A6-methacrylate |

TABLE 15
Emulsion Composition for Examples 11–13

| Material | Emulsion, g |
|---|---|
| fluorinated monomer | 11.6 |
| per Table 14 | |
| 2-ethylhexyl acrylate | 3.8 |
| N-methylol | 0.4 |
| acrylamide | |
| 2-hydroxyethyl | 0.4 |
| methacrylate | |
| Dodecyl mercaptan | 0.02 |
| 10% aqueous NaCl | 2.6 |
| acetic acid | 2.40 |
| ARMEEN DM 18D | 4.0 |
| octadecylamine | |
| vinylidene chloride^{a} | 3.8 |
| deionized water | 180 |

^{a}added to reactor

The emulsion mixture, minus the vinylidene chloride, was heated to 55° C. and emulsified in a sonicator for two minutes to provide a uniform milky white emulsion. The emulsion was charged to a flask equipped a nitrogen blanket, condenser, overhead stirrer and temperature probe, set to nitrogen sparging, and stirred at 170 rpm. When the temperature had dropped below about 30° C. the flask was switched to nitrogen blanket and the vinylidene chloride was added. The emulsion was stirred for 0.25 h followed by addition of VAZO-56 initiator (0.08 g) in deionized water (0.16 mL). The mixture was then heated to 50° C. over 0.5 h and stirred for 8 h at 50° C. The solution was then passed through a milk filter to provide an emulsion copolymer (10.5% solids).

The copolymer dispersions of Examples 11-13 were applied to SONTARA polyester-cellulosic nonwoven fabric, (74 g/m²) using a pad bath (dipping) process. The amount of fluorinated copolymer dispersion used in the pad bath was calculated to achieve a fluorine level on fabric of approximately 0.25 mg fluorine per gram fabric by weight. Three separate pad baths were prepared with dispersions of Example 11 (1.72 g), Example 12 (1.86 g), and Example 13 (1.80 g), respectively; and 280 grams of deionized water, 10.8 grams of 10 wt % aqueous sodium chloride, and 7.5 grams of FREEPEL 1225 emulsified wax. The wet pick-up % for the SONTARA fabric was about 92%. After pad application of the dispersions the treated SONTARA fabric was dried and cured in an oven until the fabric reached 250° F. (120° C.) and remained at that temperature for 3 minutes. The fabric was allowed to “rest” after treatment and cure. The treated fabric was tested for alcohol repellency using Test Method 2B using isopropyl alcohol (IPA); and penetration by water (spray impact), according to Test Method 2C, as described above. An untreated sample was used as a control. The resulting data is in Table 16.

### Comparative Example C

Comparative Example C was a SONTARA nonwoven fabric treated with a fluorochemical surface treatment agent prepared using a procedure analogous to Example 11, but using as the fluorinated monomer a mixture of methacrylates of formula F(CF₂)_{b}CH₂CH₂O C(O)—C(CH3)=CH₂, wherein b ranged from 4 to 12, and was predominately 6, and 8. The typical mixture was as follows: 0.2% of b=4, 32.6% of b=6, 35% of b=8, 18.6% of b=10, 12.7% of b=12. The fluorine content of the Examples 11 to 13 and the Comparative Example C were comparable. The SONTARA was treated with Comparative Example C in the same manner as in Examples 11-13 and was tested for alcohol repellency using Test Method 2B using isopropyl alcohol (IPA); and penetration by water (spray impact), according to Test Method 2C, as described above. The results are listed in Table 16.

TABLE 16
Alcohol Repellency and Penetration by Water of SONTARA fabric

| | Amount in 300 g | INDA alcohol^{a} | INDA spray |
|---|---|---|---|
| Example | pad bath, g | repellency rating | impact test, g |
| 11 | 1.72 | 5 | 3.7 |
| 12 | 1.86 | 4 | 2.9 |
| 13 | 1.80 | 4 | 3.9 |
| Untreated | | 0 | 15.6 |
| Comparative | 0.06 | 6 | 1.7 |
| Example C^{b} | | | |

^{a}isopropyl alcohol;
^{b}30% solids by weight

The results, listed in Table 16, indicate that nonwoven samples treated with copolymers of Examples 11-13 showed significant alcohol repellency, almost comparable to the commercial Comparative Example C (having greater than 6 carbons in its perfluoroalkyl group), and much higher alcohol repellency than that of the untreated control. Additionally, in the INDA spray impact test, wherein the less water absorbed is indicative of a more water-repellent fabric, the test indicates that nonwoven samples treated with copolymers of Examples 11-13 showed significant water repellency, comparable to the commercial Comparative Example C, and much superior to the untreated control.

### Examples 14 and 15

Example 14 was prepared using the emulsion composition listed in Table 17. The emulsion components, minus the vinylidene chloride, were mixed and heated to 55° C. and emulsified in a sonicator for two minutes until a uniform milky white emulsion resulted. The emulsion was charged to a flask equipped a nitrogen blanket, condenser, overhead stirrer and temperature probe, set to nitrogen sparging, and stirred at 170 rpm. When the temperature had dropped below about 30° C. the flask was switched to nitrogen blanket and vinylidene chloride (1.5 g and deionized water (25.0 g) were added. The solution was stirred for 0.25 h followed by addition of VAZO-56 initiator (0.08 g) in deionized water (25.0 g). The mixture was heated to 50° C. over 0.5 h and stirred for 8 h at 50° C. The emulsion was cooled to ambient room temperature, hexylene glycol (10.0 g) and deionized water (80.0 mL) were added, followed by stirring for 0.5 hours. The emulsion was passed through a milk filter to provide an emulsion copolymer having 3.0% solids and 0.75% fluorine by weight.

Example 15 was prepared in an identical manner to Example 14, using the components listed in Table 17 to provide an emulsion copolymer with 3.2% solids and 0.80% fluorine by weight.

TABLE 17
Emulsion Compositions for Examples 14 and 15

| Material | Example 14, g | Example 15, g |
|---|---|---|
| All acrylate | 5.9 | 0 |
| All methacrylate | 0 | 6.1 |
| stearyl acrylate | 1.5 | 1.5 |
| Poly(oxyethylene)-7 | 0.15 | 0.15 |
| methacrylate | | |
| N-methylol | 0.15 | 0.15 |
| acrylamide | | |
| 2-hydroxyethyl | 0.08 | 0.08 |
| methacrylate | | |
| Dodecyl mercaptan | 0.04 | 0.04 |
| sulfuric acid | 0.02 | 0.02 |
| MAPEG 600 MS | 0.67 | 0.67 |
| Polyethylene glycol | | |
| monostearate | | |
| AVITEX R | 1.0 | 1.0 |
| alkylamine | | |
| vinylidene chloride^{a} | 1.5 | 1.5 |
| deionized water | 150 | 150 |

^{a}added to reactor

The copolymer dispersions of Examples 14 and 15 were applied to 100% spunbonded-melt blown-spunbonded nonwoven polypropylene fabric (SMS PP) with a fabric weight of 39 g/m², manufactured by Kimberly-Clark, Roswell, Ga., using a pad bath (dipping) process. The amount of fluorinated copolymer dispersion used in the pad bath was calculated to achieve a fluorine level on fabric of approximately 1.20 mg fluorine per gram fabric. A pad bath (300 g) was prepared by combining the emulsion from Example 14 ( 33.5 g ), 0.15% by weight of ZELEC TY R antistatic agent (E. I. du Pont de Nemours and Company, Wilmington, Del.), 0.6% of n-hexanol, and water to make a 300 g bath. A second pad bath was prepared by combining the emulsion form Example 15 (31.4 g), 0.15% by weight of ZELEC TY R antistatic agent, 0.6% of n-hexanol and water to make a 300 g bath. The wet pick-up % for the SMS PP nonwoven fabric was about 142%. After pad application, the treated SMS PP fabric was dried and cured in an oven until the fabric reached 220° F. (105° C.) and remained at that temperature for 3 minutes. The fabric was allowed to “rest” after treatment and cure. The nonwoven SMS PP fabric was tested for alcohol repellency using Test Method 2B described above. An untreated nonwoven SMS PP fabric was used as a control. The results, listed in Table 18, showed that the emulsion copolymers of Examples 14 and 15 provided excellent alcohol repellency on SMS PP nonwoven fabrics.

### Comparative Example D

A nonwoven SMS PP fabric was treated with fluorochemical surface treatment agent having greater than 6 carbons in its perfluoroalkyl group. Comparative Example D was prepared using a procedure analogous to Example 14, but using as the fluorinated monomer a mixture of acrylates the formula F(CF₂)_{b}CH₂CH₂O C(O)—C(H)═CH₂, wherein b ranged from 6 to 16, and was predominately 8 and 10. The typical mixture was as follows: 3% of b=6, 54% of b=8,29% of b=10,12% of b=12,3% of b=14and 1% of b=16. The fluorine content of the Examples 14 and 15 and the Comparative Example D were comparable. The nonwoven SMS PP fabric was treated with Comparative Example D as described above for Examples 14 and 15 and tested for alcohol repellency using Test Method 2B described above. The results are listed in Table 18.

TABLE 18
INDA Alcohol Repellency

| | INDA alcohol repellency |
|---|---|
| Example | rating^{a} |
| 14 | 9 |
| 15 | 8 |
| Comparative D | 10 |
| Untreated | 2 |

^{a}isopropyl alcohol

The data listed in Table 18, indicate that nonwoven samples treated with copolymers of Examples 14-15 showed significant alcohol repellency comparable to the commercial Comparative Example C (having greater than 6 carbons in its perfluoroalkyl group), and much higher alcohol repellency than that of the untreated control.

### Example 16

A solution of butyl acetate (24.17 g), stearyl methacrylate (10.84 g), 2-hydroxyethyl methacrylate (8.66 g) and A11 acrylate (24.16 g) was prepared. A solution of VAZO 64 (0.42 g) (2,2¹-azobisisobutyronitrile) in butyl acetate (15.34 g) was prepared. Butyl acetate (27.85 g) was charged to a reactor equipped with a water cooled condenser, thermocouple (set to 100° C.), agitator, septum, and nitrogen sparge The solvent was heated to 100° C. and sparged for 20 min. The above monomer (5 mL) and initiator (1 mL) solutions were added to the reactor by syringe every 15 minutes for 4 hours. The reactor was cooled to ambient room temperature after an additional 6 hours of heating. Butyl acetate (55.77 g) was added to the reactor and the mixture stirred for 30 min to provide a polymer solution (159.55 g, 24% solids). The solution was tested on stone and tile substrates for repellency and stain resistance.

A treating solution was prepared by adding the product of Example 16 (1.00 g) to butyl acetate (11.0 g) to provide a 2% solids solution. The solution was applied at about 0.78 g per substrate, or about 200 g/m², in treating granite; and 1.5 g per substrate in treating saltillo substrates according to Test Methods 3 and 4. The controls were untreated substrates. The resulting data are in Tables 19 and 20.

### Comparative Example E

Comparative Example E was an agent (having greater than 6 carbons in its perfluoroalkyl group) prepared using a procedure analogous to Example 16, but using as the fluorinated monomer a mixture of acrylates the formula F(CF₂)_{b}CH₂CH₂O C(O)—C(H)═CH₂, wherein b ranged from 6 to 16, and was predominately 8 and 10. The typical mixture was as follows: 3% of b=6, 54% of b=8,29% of b=10, 12% of b=12,3% of b=14 and 1% of b=16. It was applied to granite and saltillo in a comparable manner to Example 16 and tested using Test Methods 3 and 4. The results are listed in Tables 19 and 20.

TABLE 19
Granite Repellency and Stain Test Results

| | | Untreated | Comparative |
|---|---|---|---|
| Food stains | Example 16 | Control | Example E |
| Coke | 0 | 2 | 0 |
| Mustard | 0 | 3 | 0 |
| bacon grease | 0 | 4 | 0 |
| motor oil | 0 | 4 | 0 |
| Coffee | 0 | 3 | 0 |
| lemon juice | 0 | 2 | 0 |
| grape juice | 1 | 4 | 1 |
| Ketchup | 0 | 1 | 0 |
| Italian dressing | 0 | 4 | 0 |
| Total | 1 | 27 | 1 |
| water beading | 3 | 1 | 4 |
| Oil beading | 3 | 1 | 3 |

TABLE 20
Saltillo Repellency and Stain Test Results

| | | Untreated | Comparative |
|---|---|---|---|
| Food stains | Example 16 | Control | Example E |
| Coke | 0 | 4 | 1 |
| Mustard | 2 | 4 | 2 |
| bacon grease | 2 | 4 | 0 |
| motor oil | 2 | 4 | 1 |
| Coffee | 1 | 0 | 1 |
| lemon juice | 1 | 3 | 2 |
| grape juice | 2 | 4 | 1 |
| Ketchup | 0 | 1 | 1 |
| Italian dressing | 1 | 4 | 1 |
| Total | 11 | 28 | 10 |
| water beading | 3 | 0 | 4 |
| oil beading | 4 | 0 | 4 |

The data in Tables 19 and 20 showed that the polymer dispersion of Example 16 provided improved oil repellency and water repellency to the treated substrates, as well as stain resistance comparable to the commercial Comparative Example E having more carbons in its perfluoroalkyl group, and superior to the control.

What is claimed is:

1. A copolymer composition comprising monomers copolymerized in the following percentages by weight:
(a) from about 20% to about 95% of a monomer, or mixture of monomers, of formula (I):
R_{f}—(CH₂CF₂)_{q}(CH₂CH₂)ᵣ-Z-C(O)—C(R)═CH₂ (I)
wherein
q and r are each independently integers of 1 to 3;
R_{f} is a linear or branched perfluoroalkyl group having 2 to 6 carbon atoms;
Z is —O—, —NR¹— or —S—;
R is hydrogen, Cl, F or CH₃;
R′ is hydrogen, or a C₁ to C₄ alkyl; and
(b) from about 5% to about 80% of at least one of:
(i) an alkyl (meth)acrylate monomer having a linear, branched or cyclic alkyl group of 6 to 18 carbons; or
(ii) a monomer of formula (II):
(R²)₂N—R³—O—C(O)—C(R)═CH₂ (II)
wherein
R is hydrogen, Cl, F or CH₃;
each R² is independently a C₁ to C₄ alkyl; and
R³ is a divalent linear or branched C₁ to C₄ alkylene; and
wherein the nitrogen is from about 40% to 100% salinized; or
(iii) a mixture thereof;
said composition providing oil repellency, water repellency, and stain resistance to substrates contacted therewith.

2. The copolymer composition of claim 1 further comprising at least one additional monomer copolymerized in the following percentage by weight:
(c) from about 1% to about 35% vinylidene chloride, vinyl chloride, or vinyl acetate, or a mixture thereof, or
(d) from about 0.5% to about 25% of at least one monomer selected from the group consisting of styrene, methyl-substituted styrene, chloromethyl-substituted styrene, 2-hydroxyethyl (meth)acrylate, ethylenediol di(meth)acrylate, N-methyloyl (meth)acrylamide, C₁-C₅ alkyl (meth)acrylate, and a compound of formula (III):
R⁴(OCH₂CH₂)ₘO—C(O)—C(R)═CH₂ (III)
wherein
m is 2 to about 10;
R⁴ is hydrogen, a C₁ to C₄ alkyl, or CH₂═C(R)C(O)—O—; and
each R is hydrogen, Cl, F or CH₃; or
(e) from about 0.5% to about 10% of at least one monomer of formula (IVa), (IVb) or (IVc): 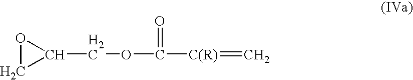
(R⁵O)₃Si—B¹-Z-C(O)—C(R)═CH₂ (IVb)
(R⁴O)₃Si—B²—C(R¹)═CH₂ (IVc)
wherein
each R is independently hydrogen, Cl, F or CH₃;
R⁵ is a linear or branched C₁ to C₄ alkyl
B¹ is a divalent linear or branched C₂ to C₄ alkylene;
B² is a covalent bond or a divalent linear or branched C₁ to C₄ alkylene; and
Z is —O—, —NR¹—, or —S—; wherein R¹ is hydrogen, or a C₁ to C₄ alkyl; or
(f) any combination thereof.

3. The copolymer composition of claim 1 wherein Z is —O—; q is 1 or 2; r is 1, and R is hydrogen or CH₃.

4. The copolymer composition of claim 1 wherein R_{f} has 6 carbon atoms.

5. The copolymer composition of claim 1 wherein component (b) is an alkyl (meth)acrylate monomer having a linear, branched or cyclic alkyl group of 6 to 18 carbons.

6. The copolymer composition of claim 1 wherein component (b) is a monomer of formula (II).

7. The copolymer composition of claim 2 wherein the additional monomer is (c) from about 1% to about 35% vinylidene chloride, vinyl chloride, vinyl acetate, or a mixture thereof.

8. The copolymer composition of claim 2 wherein the additional monomer is (d) from about 0.5% to about 25% of at least one monomer selected from the group consisting of styrene, methyl-substituted styrene, chloromethyl-substituted styrene, 2-hydroxyethyl (meth)acrylate, ethylenediol di(meth)acrylate, N-methyloyl (meth)acrylamide, C₁-C₅ alkyl (meth)acrylate, and a compound of formula (III):
R⁴(OCH₂CH₂)ₘO—C(O)—C(R)═CH₂ (III)
wherein
m is 2 to about 10;
R⁴ is hydrogen, a C₁ to C₄ alkyl, or CH₂═C(R)C(O)—O—; and
each R is hydrogen, Cl, F or CH₃.

9. The copolymer composition of claim 7 wherein the additional monomer further comprises (d) from about 0.5% to about 25% of at least one monomer selected from the group consisting of styrene, methyl-substituted styrene, chloromethyl-substituted styrene, 2-hydroxyethyl (meth)acrylate, ethylenediol di(meth)acrylate, N-methyloyl (meth)acrylamide, C₁-C₅ alkyl (meth)acrylate, and a compound of formula (III):
R⁴(OCH₂CH₂)ₘO—C(O)—C(R)═CH₂ (III)
wherein
m is 2 to about 10;
R⁴ is hydrogen, a C₁ to C₄ alkyl, or CH₂═C(R)C(O)—O—; and
each R is hydrogen, Cl, F or CH₃.

10. A method of treating a substrate to impart oil repellency, water repellency and stain resistance comprising contacting the substrate with a copolymer composition comprising monomers copolymerized in the following percentages by weight:
(a) from about 20% to about 95% of a monomer, or mixture of monomers, of formula (I):
R_{f}—(CH₂CF₂)_{q}(CH₂CH₂)ᵣ-Z-C(O)—C(R)═CH₂ (I)
wherein
q and r are each independently integers of 1 to 3;
R_{f} is a linear or branched perfluoroalkyl group having 2 to 6 carbon atoms;
Z is —O—, —NR¹— or —S—;
R is hydrogen, Cl, F or CH₃;
R¹ is hydrogen, or a C₁ to C₄ alkyl; and
(b) from about 5% to about 80% of at least one of:
(i) an alkyl (meth)acrylate monomer having a linear, branched or cyclic alkyl group of 6 to 18 carbons; or
(ii) a monomer of formula (II):
(R²)₂N—R³—O—C(O)—C(R)═CH₂ (II)
wherein
R is hydrogen, Cl, F or CH₃;
each R² is independently a C₁ to C₄ alkyl; and
R³ is a divalent linear or branched C₁ to C₄ alkylene; and
wherein the nitrogen is from about 40% to 100% salinized; or
(iii) a mixture thereof.

11. The method of claim 10 wherein said copolymer composition further comprises at least one additional monomer copolymerized in the following percentage by weight:
(c) from about 1% to about 35% vinylidene chloride, vinyl chloride, or vinyl acetate, or a mixture thereof; or
(d) from about 0.5% to about 25% of one or more monomer(s) selected from the group consisting of styrene, methyl-substituted styrene, chloromethyl-substituted styrene, 2-hydroxyethyl (meth)acrylate, ethylenediol di(meth)acrylate, N-methyloyl (meth)acrylamide, C₁-C₅ alkyl (meth)acrylate, and a compound of formula (III):
R⁴(OCH₂CH₂)ₘO—C(O)—C(R)═CH₂ (III)
wherein
m is 2to about 10;
R⁴ is hydrogen, a C₁ to C₄ alkyl, or CH₂═C(R)C(O)—O—; and
each R is hydrogen, Cl, F or CH₃; or
(e) from about 0.5% to about 10% of one or more monomer(s) of formula (IVa), (IVb) or (IVc): 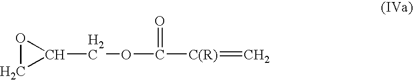
(R⁵O)₃Si—B¹-Z-C(O)—C(R)═CH₂ (IVb)
(R⁴O)₃Si—B²—C(R¹)═CH₂ (IVc)
wherein
each R is independently hydrogen, Cl, F or CH₃;
R⁵ is a linear or branched C₁ to C₄ alkyl;
B¹ is a divalent linear or branched C₂ to C₄ alkylene;
B² is a covalent bond or a divalent linear or branched C₁ to C₄ alkylene; and
Z is —O—, —NR¹—, or —S—; wherein R¹ is hydrogen, or a C₁ to C₄ alkyl; or
(f) any combination thereof.

12. The method of claim 10 wherein Z is —O—; q is 1 or 2; r is 1, and R is hydrogen or CH₃.

13. The method of claim 10 wherein R_{f} has 6 carbon atoms.

14. The method of claim 10 wherein (b) is an alkyl (meth)acrylate monomer having a linear, branched or cyclic alkyl group of 6 to 18 carbons.

15. The method of claim 10 wherein (b) is a monomer of formula (II).

16. The method of claim 10 wherein the substrate is a fibrous substrate selected from the group consisting of cotton, rayon, silk, wool, paper, hemp, polyester, spandex, polypropylene, polyolefin, polyamide, aramid, nonwoven, wood, paper and leather.

17. The method of claim 16 wherein the substrate is a nonwoven selected from the group consisting of paper, cellulose acetate and nitrate, polyamides, polyesters, polyolefins, and combinations thereof.

18. The method of claim 10 wherein the substrate is a hard surface substrate selected from the group consisting of stone, glass, masonry, concrete, unglazed tile, brick, porous clay, granite, limestone, grout, mortar, marble, gypsum board, terrazzo, and composite materials.

19. A substrate having contacted a polymer of claim 1.

20. The substrate of claim 19 that is a fibrous substrate selected from the group consisting of cotton, rayon, silk, wool, paper, hemp, polyester, spandex, polypropylene, polyolefin, polyamide, aramid, nonwoven, wood, paper and leather, or a hard substrate selected from the group consisting of stone, glass, masonry, concrete, unglazed tile, brick, porous clay, granite, limestone, grout, mortar, marble, gypsum board, terrazzo, and composite material.
